(19) United States
(12) Patent Application Publication
(10) Pub. No.: US 2003/0015973 A1
(43) Pub. Date: Jan. 23, 2003

(54) Solid state traffic light with predictive failure analysis

(76) Inventors: Kevin Ovens, Plano, TX (US); Thomas C. Shinham, Rowlett, TX (US); Patrick R. Smith, Garland, TX (US)

Correspondence Address: Bobby D. Slaton, Jackson Walker, L.L.P., Suite 600, 2435 North Central Expressway, Richardson, TX, 75080, US

(21) Appl. No.: 10/198,486

(22) Filed: Jul. 18, 2002

Related U.S. Application Data
(60) Provisional application No. 60/306,232, filed on Jul. 18, 2001.

(51) Int. Cl. H05B 39/04

(52) U.S. Cl. 315/291; 315/119

(57) ABSTRACT

An apparatus, system and method for determining when an LED used in traffic signal device will fail. The traffic signal apparatus comprises a housing, a solid state light disposed therein and having an array of LED generating a light output therefrom, and a circuit adapted to predict failure of the solid state light source based on a plurality of parameters at which the LED array operates. The method comprises the acts of sensing the light output generated by the LED array and sensing the ambient temperature thereby. These sensing acts are then followed by a calculating act wherein a time-average temperature value is calculated based on the intensity of both the light output and the ambient temperature. The calculating act is then followed by another calculating act wherein a time-average duty cycle value of the power source powering the LED array is determined. Next, a comparing act compares the time-average temperature value with the time-average duty cycle of the power source to advantageously determine when the LED will reach the end-of-life.

### PRIORITY CLAIM

Priority is claimed from U.S. Provisional Patent application Serial No. 60/306,232 entitled “Solid State Traffic Light with Predictive Failure Analysis” filed Jul. 18, 2001.

### CROSS REFERENCE TO RELATED APPLICATION

The present invention is related to commonly assigned co-pending U.S. patent application Ser. No. 09/641,424, entitled “Solid State Traffic Light with Predictive Failure Mechanisms”, filed Aug. 17, 2000, the teachings of which are incorporated herein by reference.

### FIELD OF THE INVENTION

Applicant's invention relates to traffic light signals, and more particularly, an apparatus, system, and method for determining when an LED (light emitting diode) used in a traffic signal device will fail.

### BACKGROUND OF THE INVENTION

Traffic signal lights have been around for years and have been used to efficiently control traffic through intersections. While traffic signals have been around for years, improvements continue to be made. Currently, solid state light sources are replacing incandescent light sources in traffic signals. The life time of traditional solid state light sources is far longer than that of incandescent light sources, currently having a useful operational life of between ten to a hundred times that of traditional incandescent light sources. This additional life time helps compensate for the additional replacement costs associated with solid state light sources.

Generally, the light output produced by an LED will naturally degrade over time as the LED ages. Moreover, it has been shown that light degradation can occur much sooner if the LED is exposed to above-average temperatures, even if the LED, by itself, generates little heat. Consequently, since traffic signal devices generally operate under changing temperature conditions, predicting when a LED is going to fail is difficult. In a traffic signal device, a LED that fails prematurely leaves the signal device functionally inoperable. As such, a traffic device that is inoperable is likely to cause commuter confusion and hamper the flow of traffic. Or worse, it can also increase the likelihood of traffic accidents.

Accordingly, there is needed a novel device, system, and method that not only extends the operational life of a LED, but also predicts when an LED used in traffic signal device is likely to fail.

### SUMMARY OF THE INVENTION

The present invention achieves technical advantages as an apparatus and method for detecting and predicting failure of a solid state light source used in a traffic signal device.

In one embodiment, the invention is a traffic signal apparatus that monitors and records multiple key parameters at which an LED traffic signal operates, and based on these parameters, predicts when in the future the signal should be replaced prior to failure. The apparatus includes a controller adapted to The controller operates by measuring the temperature of the LEDs by means of monitoring the resistance of a temperature sensitive resistor mounted next to the LEDs. The controller also measures the instantaneous optical power emitted from the LEDs by means of a high speed photodiode that will generate a voltage proportional to the flux density of the source. LEDs are operated in a pulse width modulated format using a constant current while on and varying the duty factor to increase or decrease the optical flux. The controller will adjust the duty factor of the LED drive signal so as to provide the minimum required optical signal as measured by the photodiode.

In another embodiment, the invention is a method that determines multiple parameters at which an LED (light emitting diode) operates within a traffic signal. The method then provides the act of correlating at least two of these parameters to predict when the LED will fail. In selected embodiments, these measured parameters include LED light output, LED ambient temperature, and LED drive current.

In yet another embodiment, the invention is a method for increasing the operational life of a solid state traffic signal device. The method is achieved by the act of sensing a light output generated by an LED array, as well as the ambient temperature proximate the LED array. This is then followed by the act of calculating a time-average temperature value based on the light output and temperature measurements. This is followed by the act of calculating a time-average-duty current cycle value based on the drive current of a power source used to drive the LED array. The method also includes the act of comparing the time-average temperature and the time-average current duty cycle to provide an end-of-life LED value which is used to predict, in the future, when an individual LED in the array should be replaced.

The present invention achieves technical advantages by determining key information regarding LED traffic signal operation, and predicting when the signal should be replaced. As such, the estimated time of failure is long enough that replacement can be scheduled.

### BRIEF DESCRIPTION OF THE DRAWINGS

For a more complete understanding of the present invention, reference is made to the following detailed description taken in conjunction with the accompanying drawings wherein:

FIG. 1 is one embodiment of a solid state traffic signal device;

FIG. 2 shows a graph of a LED light intensity versus time in accordance with an exemplary embodiment of the present invention;

FIG. 3 shows a graph of a drive current duty cycle versus time using a time-average temperature algorithm in accordance with an exemplary embodiment of the present invention;

FIG. 4 shows LED light output intensity across time based on an outside temperature of 85° C. at 85% humidity in accordance with an exemplary embodiment of the present invention;

FIG. 5 shows LED light output intensity across time based on an outside temperature of 0° C. at 0% humidity in accordance with an exemplary embodiment of the present invention;

FIG. 6 shows LED output normalized to 20° C. in accordance with an exemplary embodiment of the present invention; and

FIGS. 7 illustrate an algorithm for predicting LED failure in accordance with an exemplary embodiment of the present invention.

### DETAILED DESCRIPTION OF THE PREFERRED EMBODIMENTS

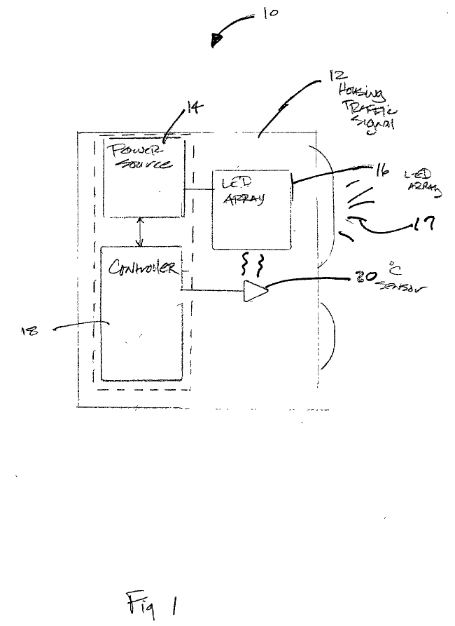

Referring to FIG. 1 there is solid state traffic signal apparatus 10 in accordance with an exemplary embodiment of the present invention. The device 10 includes a housing 12 having a solid state light source 16 therein. The solid state light source 16 generally comprises an array of LEDs adapted to generated a light output 17. In addition, the array 16 is coupled to and driven by a controller 18. Controller 18 includes a power source 14 for generating a drive current to selectively drive the LED array 16. A temperature sensor 20 is seen to be coupled to the controller 18 and is adapted to measure the ambient temperature closely proximate to traffic signal housing 10.

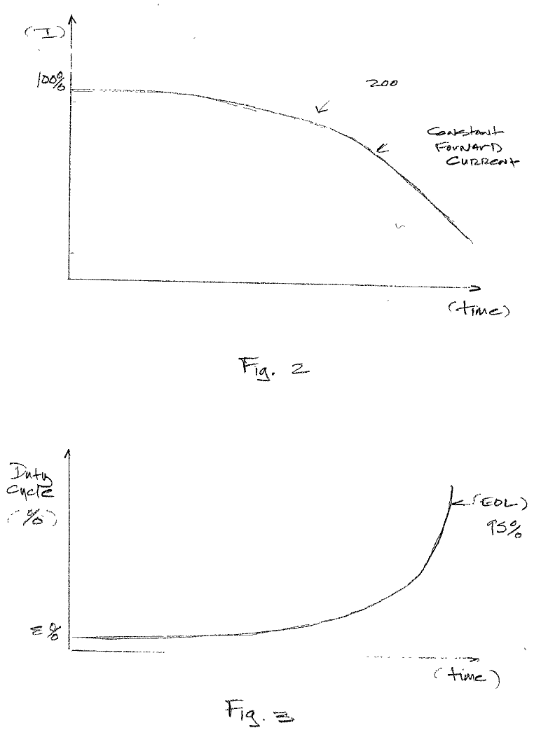

Referring to FIG. 2, there is shown a graph of the typical lifetime characteristics of an individual LED of array 16. As depicted in FIG. 2, for a constant drive current 200, a light output produced by the LED naturally degrades over time. In one preferred embodiment, the drive current used to drive the LED array 16 may be selectively generated by controller 18. Preferably, each LED in the array 16 is pulse width modulated (PMW) providing current during a predetermined portion of the duty cycle. Using an optical feedback technique, the controller 18 is adapted to automatically adjust the duty cycle altering the forward drive current, which in turns alters the light output. Thus, in one preferred embodiment, the invention periodically adjusts the drive current so as to compensate for decreasing LED light output as the LED ages. Moreover, the present invention is capable of predicting the end-of-life (EOL) of a normal LED when the temperature and the forward current are known, as will be described more shortly.

FIG. 3 shows a graph of a current duty cycle across time that uses a time-average temperature algorithm in accordance with an exemplary embodiment of the present invention. To produce a constant the light intensity by the LED array 16, the drive current may be upwardly adjusted by changing the drive current duty cycle, as shown.

It is realized that sudden and extreme changes in ambient temperature also degrades the light output intensity of an LED over time, thereby reducing its life expectancy. The LED array 16 is provided to the controller 18 via the temperature sensor 20. In one embodiment, an algorithm executed by controller 18 takes the known ambient temperature characteristics of individual LEDs in the LED array 16 and produces a time-average temperature value from which the lifetime performance of the LEDs can be predicted. This time-average temperature value may be calculated by controller 18 by monitoring the temperature proximate the LEDs 16 at specific time intervals, summing the measured temperatures correlating to the time intervals, and then summing this summed value by the number of intervals.

For example, in the preferred embodiment a clock associated with the controller to which temperature sensors are connected monitors the temperature of the LEDs' every 15 seconds. Assume that a series of 10 measurements yields the following Celsius values: 30, 30, 31, 32, 32, 31, 31, 30, 29, 30. The successive time-average temperatures will be 30, 30, 30.33, 30.75, 31, 31, 31, 30.875, 30.67, 30.6. If an LED has a nominal life of X years operating at a constant 30 degrees Celsius, then the life of the LED, subjected to the foregoing ambient temperatures, will be shortened by some ΔX which is related to the temperature averages which exceed 30 degrees Celsius. Thus, using the algorithm to generate the time-average temperature value, the LED failure may be accurately predicted and may be defined as a function of both time and temperature.

As noted earlier, if the LED light output 16 is kept constant using optical feedback, the light output generated by LED array 16 may be represented as a function of drive current duty cycle. However, in a selected embodiment, since the LED array 16 generally operates over a varying temperature range during its life time, the duty cycle may also be adjusted based on a time-average temperature duty cycle value. Thus, when the measured time-average temperature duty cycle value exceeds a predetermined threshold, the LED is considered to be at the end-of-life (EOL). In a preferred embodiment, the EOL value of the individual LEDs may be determined by an algorithm that extrapolates a value using previously stored times and current duty cycles values versus current times and duty cycle values. If, for example, an individual LED has an expected lifetime of 100,000 hours, then the end-of-life of the LEDs is estimated by determining the time-average temperature adjusted duty cycle every 10,000 hours, then using the last two recorded time and current points to quadratically extrapolate, an end-of-life value.

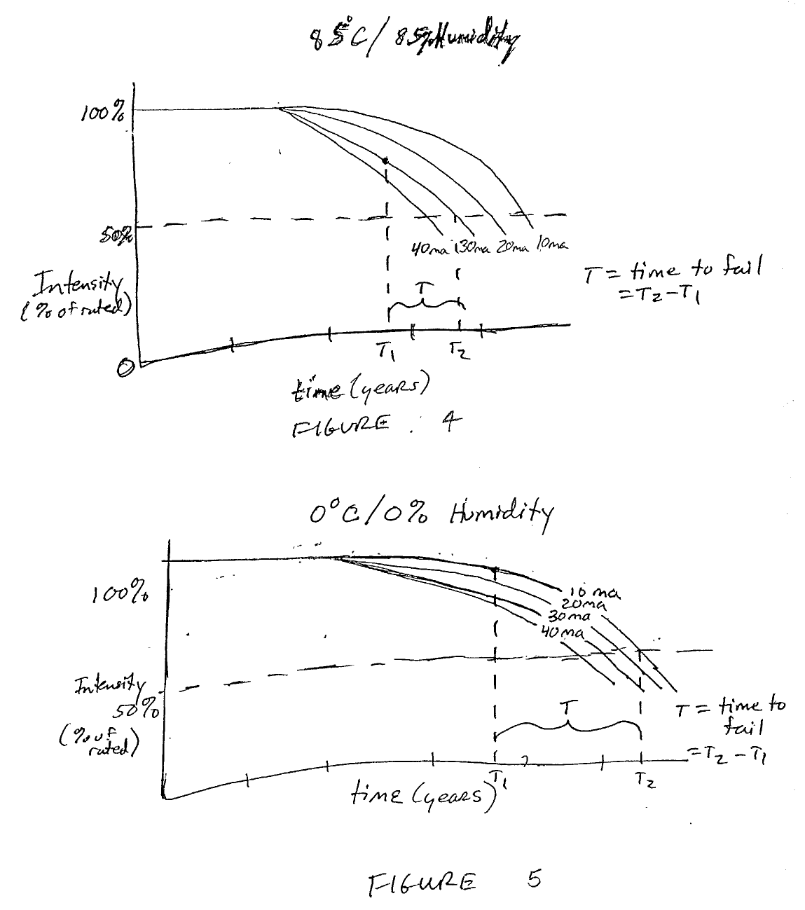

Referring to the graphs in FIGS. 4 and 5, the known operating characteristics of the particular an LED produced by the LED manufacture are illustrated and stored in memory of the controller 18, allowing the controller 18 to predict when the LED is about the fail. Knowing the operating temperatures at which the LED operates using sensor 20, the drive current driving the LED, and total time the LED has been on, the controller 18 determines which operating curve in FIG. 4 and FIG. 5 applies to the current operating conditions, and then determines the time until the LED will degrade to a performance level below spec, i.e. below DOT minimum intensity requirements.

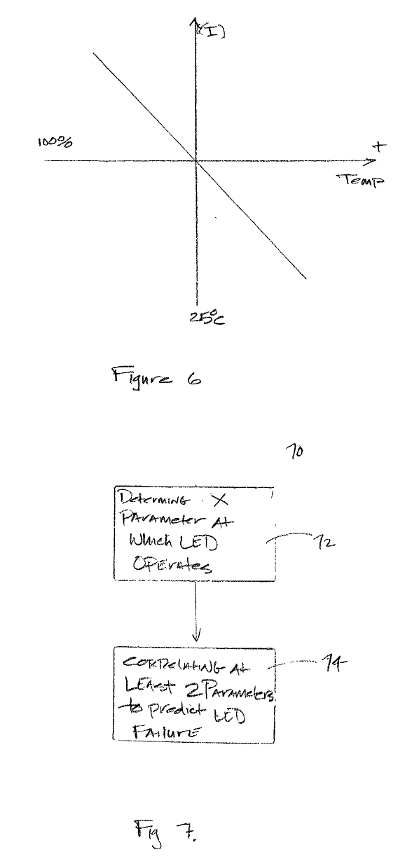

Referring now to FIG. 6, therein is shown a graph of the light output versus temperature curve normalized at 25° C. In a preferred embodiment, the present invention allows for a self-adjusting light output in response to a change in temperature. As shown, a higher light output is generated by the controller 18 when the LED array 16 is operating in colder temperatures. Alternatively, when the array 16 is subjected to higher temperatures, it generates a lower light output.

FIG. 7 illustrates an LED failure detection algorithm 70 predicting failure of an LED source 16 used in a traffic signal in accordance with an exemplary embodiment of the present invention. The failure algorithm 70, executed by controller 18, predicts when the solid state light fail, and when the solid state light apparatus 10 will produce a beam of light having an intensity below a predetermined minimum intensity such as that established by the DOT. The algorithm 70 generally begins with the act of determining parameters at which the LED operates. The determining act 72 is then followed by a correlating act 74 which correlates at least two of these determined parameters to predict failure of the LED. Preferably, these parameters include the LED's light output, the drive current duty cycle used to drive the individual LEDs in the LED array 16, and the ambient temperature proximate the signal housing 10.

While the invention has been described in conjunction with preferred embodiments, it should be understood that modifications will become apparent to those of ordinary skill in the art and that such modifications are therein to be included within the scope of the invention and the following claims.

What is claimed is:

1. A traffic control device, comprising:
a housing;
a solid state light source disposed within the housing and having an array of LEDs generating a light output; and
a circuit predicting failure of said solid state light source based on a plurality of parameters at which said LED array operates.

2. The device of claim 1 wherein one said parameter comprises an LED light output.

3. The device of claim 1 wherein one said parameter comprises an LED drive current.

4. The device of claim 1 wherein one said parameter comprises an LED ambient temperature.

5. The device of claim 4 wherein said circuit generates a time-average temperature value.

6. The device of claim 3 wherein said circuit generates a time-average current duty cycle value.

7. A method for predicting the life span of an LED used in a traffic signal device having a controller and a power source, comprising the steps of:
sensing a light output generated by an LED;
sensing the ambient temperature proximate said LED;
calculating a time-average temperature value using said ambient temperature;
calculating a time-average-duty cycle value of the power source used to drive said LED; and
comparing said time-average temperature value with said time-average duty cycle to determine when the LED will reach the end-of-life.

8. The method of claim 7 wherein said time-average temperature calculating step comprises measuring the ambient temperature at predetermined time intervals.

9. The method of claim 7 wherein said temperature is measured using a temperature sensor.

10. The method of claim 7 wherein said time-average temperature calculating step further comprises measuring the light output at predetermined time intervals associated with the LED temperature.

11. The method of claim 7 wherein said time-average duty cycle calculating step comprises measuring the duty cycle of said power source at predetermined time intervals.

12. A method of detecting failure of a solid state light source used in a traffic signal device, comprising the steps of:
determining a plurality of parameters at which an LED operates within the traffic signal device; and
correlating at least two said parameters to predict when the light generated by an LED will fail.

13. The method of claim 12 wherein one said parameter comprises a light output of the LED.

14. The method of claim 12 wherein one said parameter comprises an LED drive current.

15. The method of claim 14 wherein one said parameter comprises ambient temperature proximate the LED.

16. The method of claim 15 further comprising the step of adjusting a duty cycle of a the LED drive current as the light output falls due to the sensed effects of the ambient temperature proximate the LED.

17. The method of claim 14 further comprising the step of determining a time-average duty cycle of said drive current per unit time.

18. The method of claim 17 further comprising the step of calculating a time-average duty cycle value of said LED temperature.

19. The method of claim 18 further comprising the step of determining an end-of-life (EOL) of said LED based on the time-average current duty cycle and time-average current duty cycle.

20. The method of claim 15 wherein said time-average current duty cycle per unit time is proportional to the time-average LED temperature.
